(19) United States
(12) Patent Application Publication
(10) Pub. No.: US 2026/0109819 A1
(43) Pub. Date: Apr. 23, 2026

(54) SILICONE ADMIXTURE, INK AND MOLDING MATERIAL CONTAINING THE SAME, CURED PRODUCTS THEREOF, AND METHOD OF PRODUCING CURED PRODUCTS

(71) Applicants: SMP Technologies Inc., Tokyo (JP); Meinan Rubber Ind., Inc., Chita-Shi (JP)

(72) Inventors: Shunichi HAYASHI, Tokyo (JP); Toshihiro OKAMOTO, Chita-Shi (JP)

(73) Assignees: SMP Technologies Inc., Tokyo (JP); Meinan Rubber Ind., Inc., Chita-Shi (JP)

(21) Appl. No.: 19/361,826

(22) Filed: Oct. 17, 2025

(30) Foreign Application Priority Data
Oct. 18, 2024 (JP) 2024-183924

(51) Int. Cl. C08G 77/20; B29C 39/38; B29K 83/00; C08K 3/08; C08L 83/04; C09D 11/102

(52) U.S. Cl. CPC C08G 77/20; B29C 39/38; C08K 3/08; C08L 83/04; C09D 11/102; B29K 2083/005; C08K 2201/019

(57) ABSTRACT

It is an object of the present invention to provide a silicone rubber that can be produced at a lower cost than before and is compatible with human bodies. The silicone admixture according to the present invention contains a castable silicone rubber, a vulcanizing agent, and a silicone high polymer having no cross-linking site and is capable of becoming a cure product having loss tangent (tan δ) of 0.2 or more at 10° C. to 40° C. The castable silicone rubber is a liquid silicone rubber that is curable by addition reaction, and the vulcanizing agent is a platinum compound. The silicone high polymer having no cross-linking site is a dimethyl silicone high polymer.

### CROSS REFERENCE TO RELATED APPLICATIONS

This application claims the benefit of Japanese Patent Application No. 2024-183924 filed on Oct. 18, 2024, the content of which is incorporated herein by reference.

### TECHNICAL FIELD

The present invention relates to a silicone admixture, an ink and a molding material containing the silicone admixture, cured products thereof, and methods for producing the cured products.

### BACKGROUND ART

In recent years, demand for silicone rubbers has grown increasingly, and there is a need for development of silicone rubbers having excellent properties.

PTL 1 discloses a silicone admixture containing a millable silicone rubber, a silicone high polymer having no cross-linking site, a vulcanizing agent, and a rubber reinforcing silica. A cured product of the silicone admixture described in PTL 1 is a silicone rubber compatible with human bodies.

### CITATION LIST

### Patent Literature

### [PTL 1]

Japanese Unexamined Patent Application, Publication No. 2019-85490 (see claim 1 and Paragraphs and [0031].)

### SUMMARY OF INVENTION

### Technical Problem

It has been required for the production of the cured product of the silicone admixture described in PTL 1 to further reduce production cost.

An object of the invention is to provide a silicone rubber that can be produced at a lower cost than before and is compatible with human bodies.

### Solution to Problem

In order to solve the above problem, the present invention employs the following solutions.

The present invention provides a silicone admixture containing a castable silicone rubber, a vulcanizing agent, and a silicone high polymer having no cross-linking site, wherein the silicone admixture is capable of becoming a cured product having loss tangent (tan δ) of 0.2 or more at 10° C. to 40° C.; an ink and a molding material containing the silicone admixture; and cured products thereof.

The silicone admixture according to the present invention described above is capable of becoming a cured product having tan δ of 0.2 or more at 10° C. to 40° C. by curing the castable silicone rubber with a vulcanizing agent. Such a cured product has high compatibility with human bodies. When such a cured product is used in a part being in contact with the human skin, comfortable wearing feeling is provided.

The castable silicone rubber may be cross-linked (cured) at a lower temperature and in a shorter period of time than the millable silicone rubber described in PTL 1. Therefore, by employing the castable silicone rubber, it is possible to reduce an energy consumption required for producing the cured product. As a result, production cost can be reduced.

In addition, since the castable silicone rubber is cross-linked at a lower temperature than the millable silicone rubber, it is possible to cure the castable silicone rubber together with a substrate that has a low melting point and thus could not tolerate the curing temperature of the millable silicone rubber. Using such a silicone admixture as an ink can expand the range of material choices for a printing substrate.

A castable silicone rubber has a lower viscosity than a millable silicone rubber. Therefore, the silicone admixture employed with the castable silicone rubber has an easy-to-adjust viscosity and is suitable to be used as a molding material for injection molding and press molding.

In one aspect of the present invention described above, the castable silicone rubber is a liquid silicone rubber that is curable by addition reaction, and the vulcanizing agent may be a platinum compound.

In one aspect of the present invention described above, the silicone high polymer having no cross-linking site may be a dimethyl silicone high polymer.

In one aspect of the present invention described above, the silicone admixture preferably contains 20 parts or more by weight of the silicone high polymer having no cross-linking site based on 100 parts by weight of the castable silicone rubber.

The cross-linked castable silicone rubber and the silicone high polymer having no cross-linking site in the cured product serve as a hard segment and a soft segment respectively. As a result of adjusting the proportions of these hard and soft segments, a silicone admixture exhibiting desired tan δ after curing can be obtained.

In one aspect of the present invention described above, the silicone admixture may further contain a low-viscosity silicone oil having no methyl group within a molecule.

In addition, the present invention provides a method for producing a cured product, including: mixing a castable silicone rubber, a silicone high polymer having no cross-linking site, and a vulcanizing agent to prepare a mixed liquid; printing the mixed liquid onto a substrate having a higher melting point than a curing temperature of the mixed liquid; and then heating the substrate printed with the mixed liquid to a temperature lower than the melting point of the substrate and higher than the curing temperature and obtaining the cured product having loss tangent (tan δ) of 0.2 or more at 10° C. to 40° C.

The castable silicone rubber may be cured at a temperature lower than the melting point of the substrate. Therefore, there is no need to worry about any damage to the substrate from heat even if the printed mixed liquid is heated together with the substrate.

Furthermore, the present invention provides a method for producing a cured product, including: mixing a castable silicone rubber, a silicone high polymer having no cross-linking site, and a vulcanizing agent to prepare a mixed liquid; filling a mold with the mixed liquid; and then heating the mold filled with the mixed liquid to 110° C. or more and obtaining the cured product having loss tangent (tan δ) of 0.2 or more at 10° C. to 40° C.

By employing a castable silicone rubber, a cured product can be produced at a lower temperature and in a shorter period of time than when a millable silicone rubber is used.

### Advantageous Effects of Invention

The present invention can provide a silicone rubber that can be produced with a lower cost than a cured product of a silicone admixture containing a millable silicone rubber and is compatible with human bodies.

### BRIEF DESCRIPTION OF DRAWINGS

FIG. 1 is a graph of a frequency-dependent dynamic viscoelasticity of Example 1.

FIG. 2 is a graph of a frequency-dependent dynamic viscoelasticity of a cured product formed by cross-linking the castable silicone rubber under the same conditions.

FIG. 3 is a graph of a frequency-dependent dynamic viscoelasticity of Example 2.

FIG. 4 is a graph of a frequency-dependent dynamic viscoelasticity of Example 3.

### DESCRIPTION OF EMBODIMENTS

One embodiment for the silicone admixture according to the present invention, one embodiment for an ink and a molding material containing the silicone admixture, one embodiment for cured products thereof, and one embodiment for a method for producing the cured products are described below.

The silicone admixture according to the present embodiment is suitable for use as a silicone ink and a molding material for injection molding and press molding. A cured product of the silicone admixture has mechanical loss tangent (tan δ) of 0.2 or more at 10° C. to 40° C.

The desired value of tan δ for the cured product of the silicone admixture can be achieved by optimizing the proportion of the castable silicone rubber to the silicone high polymer.

### (Silicone Admixture)

The silicone admixture contains a castable silicone rubber, a vulcanizing agent, and a silicone high polymer having no cross-linking site.

The castable silicone rubber is the main component of the silicone admixture. “Main component” herein is a component that may have the most impact to the properties of a silicone rubber (cured product) as an elastic body formed by curing the silicone admixture.

The castable silicone rubber is a silicone rubber that is liquid at room temperature. For example, the castable silicone rubber may have a viscosity of 50 Pa·s to 2,000 Pa·s at room temperature (23° C.).

The castable silicone rubber is a monomer with a molecular weight of several hundreds to several thousands. The castable silicone rubber is composed of siloxane bonds having a backbone of silicon-oxygen bonds (—Si—O—) and has addition-reactive functional groups on side chain that contribute to cross-linking. The addition-reactive functional group is a vinyl group and a silicon-bonded hydrogen atom (Si—H group). The castable silicone rubber may be composed of an organopolysiloxane having vinyl groups and an organohydrogenpolysiloxane having Si—H groups. The castable silicone rubber may be cross-linked by addition reaction using a vulcanizing agent (catalyst) whereby the Si—H group reacts with the vinyl group. The castable silicone rubber may be a liquid silicone rubber that is commercially available for LIMS (liquid silicone rubber injection molding system). The temperature for addition reaction (curing temperature) of the castable silicone rubber is 110° C. or more, preferably 120° C. or more and 150° C. or less. The castable silicone rubber may be KE-1950-3 series manufactured by Shin-Etsu Chemical Co., Ltd.; LIM 6000 series manufactured by Momentive Performance Materials Inc.; Elastosil LR series manufactured by Wacker Asahikasei Silicone Co., Ltd., and the like.

The vulcanizing agent acts as a catalyst. The vulcanizing agent is a platinum compound. In the silicone admixture, it is sufficient that the vulcanizing agent is added in an amount required for addition reaction of almost all addition-reactive functional groups. Based on the total amount of the castable silicone rubber, the content of the vulcanizing agent is usually in the range of 0.5 ppm to 1,000 ppm, preferably in the range of 1 ppm to 500 ppm, more preferably in the range of 10 ppm to 100 ppm based on mass converted to catalytic metal element (platinum group metal element).

The castable silicone rubber may be one-component or two-component type.

The one-component castable silicone rubber contains the first castable silicone rubber with vinyl groups and the second castable silicone rubber with silicon-bonded hydrogen atoms. The vulcanizing agent is mixed with the castable silicone rubber just before use, and the obtained mixed liquid is heated for cross-linking.

In the two-component type, the first castable silicone rubber with vinyl groups and the second castable silicone rubber with silicon-bonded hydrogen atoms are stored separately, and just before use, both of them and the vulcanizing agent are mixed and heated for cross-linking.

If the castable silicone rubber is a two-component type, either of the components may contain the vulcanizing agent.

The silicone high polymer having no cross-linking site (hereinafter, referred to as a silicone high polymer) does not have cross-linking site of a methyl group, a vinyl group, and the like. The silicone high polymer does not contribute to the promotion of the curing (cross-linking) reaction of the castable silicone rubber. The silicone high polymer is, for example, a dimethyl silicone high polymer. A dimethyl silicone high polymer has elasticity and viscosity.

“High polymer” herein refers to a series of linear polymers that have been polymerized to an extent that the physical properties (especially the viscoelastic properties) do not change significantly by the relative molecular mass (see K6900-1994 and ISO 472:1988). More specifically, the molecular weight of “high polymer” is about 50,000 to 1,000,000.

The silicone admixture contains 20 parts or more by weight of the silicone high polymer based on 100 parts by weight of the castable silicone rubber. If the proportion of the silicone high polymer is too low, it is not possible to achieve loss tangent (tan δ) of 0.2 or more for the cured product of the silicone admixture. If the proportion of the silicone high polymer is higher, the viscosity of the silicone admixture also increases. The viscosity of the silicone admixture is appropriately set in accordance with the product of application.

For example, if the silicone admixture is applied to an ink, it may be set so that the silicone admixture may contain 20 parts or more by weight and 50 parts or less by weight, preferably 25 parts or more by weight and 50 parts or less by weight of the silicone high polymer based on 100 parts by weight of the castable silicone rubber.

For example, if the silicone admixture is applied to a molding material for LIMS (liquid silicone rubber injection molding system) or press molding, it may be set so that the silicone admixture may contain 20 parts or more by weight and 100 parts or less by weight, preferably 25 parts or more by weight and 100 parts or less by weight of the silicone high polymer based on 100 parts by weight of the castable silicone rubber.

The silicone admixture may contain a plasticizer, a lubricant, and a reinforcing agent.

A plasticizer is a substance that can improve fluidity of the silicone admixture and adjust the viscosity of the silicone admixture. The plasticizer may be a low-viscosity silicone oil having no methyl group within the molecule. The plasticizer does not have a methyl group within the molecule. The plasticizer does not contribute to the promotion of the curing (cross-linking) reaction of the castable silicone rubber. “Low-viscosity” herein means a viscosity of 100 Pa·s or less.

The content of the plasticizer in the silicone admixture is appropriately set in accordance with the content of the silicone high polymer and the application of the silicone admixture.

For example, if the silicone admixture is applied to an ink, the silicone admixture may contain the plasticizer of 2.5 times or less, preferably 1.0 to 2.5 times of the content of the silicone high polymer containing no cross-linking site.

For example, if the silicone admixture is applied to LIMS (liquid silicone rubber injection molding system) or press molding, the silicone admixture may contain the plasticizer of 0 times to 2.5 times of the content of the silicone high polymer having no cross-linking site.

A lubricant is an additive for reducing tackiness of a silicone rubber and providing the silicone rubber with slip ability. The lubricant does not contribute to the promotion of the curing (cross-linking) reaction of the castable silicone rubber. The lubricant is preferably a silicone-based material. More specifically, the lubricant material is organosilicone-based.

When the silicone admixture is applied to a molding material, the lubricant acts as an internal mold releasing agent. By containing the lubricant, the cured product of the silicone admixture becomes less adhesive to the mold, thereby assisting the demolding.

The lubricant may be added during production if necessary. For example, if demolding needs to be improved, the silicone admixture may contain 0.3 parts or less by weight, preferably 0.2 to 0.3 parts by weight of the lubricant based on 100 parts by weight of the sum of the castable silicone rubber and the silicone high polymer.

A reinforcing agent is silica particles for providing the cured product of the silicone admixture with hardness and strength. The reinforcing agent does not contribute to the promotion of the curing (cross-linking) reaction of the castable silicone rubber.

The silicone admixture may contain 20 parts or less by weight of the reinforcing agent based on 100 parts by weight of the sum of the castable silicone rubber and the silicone high polymer. If the amount of the reinforcing agent is too large, the castable silicone rubber becomes diluted, and as a result, the cross-linking reaction may not proceed. If the amount of the reinforcing agent is large, blanching during deformation is significant. If the amount of the reinforcing agent is too small, the cured product of the silicone admixture cannot maintain desired hardness.

The lubricant and the reinforcing agent are appropriately selected from silicone-based materials with high compatibility in accordance with the types of the castable silicone rubber and the silicone high polymer. Unifying the types of materials improves the compatibility. By selecting materials with high compatibility, it is possible to avoid problems such as the materials generating foams due to reaction inhibition.

Furthermore, the silicone admixture may contain an additive such as functional minerals, pigments, and aroma chemicals, as long as the additive does not interfere with the cross-linking reaction of the castable silicone rubber and in addition has no influence on tan δ of the cured product. “No influence” herein means an extent that loss tangent (tan δ) is in the desired range at the desired temperatures of 10° C. to 40° C.

Each component of the silicone admixture is separately stored until just before use. Especially, the component of the castable silicone rubber having addition-reactive functional groups that contribute to the cross-linking reaction is stored separately from the vulcanizing agent.

Each component contained in the silicone admixture that is mixed just before use is dispersed in the silicone admixture.

### (Cured Product)

The cured product formed by heating and curing the silicone admixture may have loss tangent (tan δ) of 0.2 or more at 10° C. to 40° C. The obtained cured product is a thermoplastic and thermosetting elastomer having a frequency dependency of tan δ (dilatancy).

The hardness of the cured product (type A durometer) is preferably 0 or more and 30 or less. The (JIS-A type) hardness of the cured product is preferably 0 or more and 30 or less. When selecting a castable silicone rubber that can achieve high hardness, the cured product will strongly exhibit its properties as an elastic body. As a result, tan δ is unlikely to be exhibited. The JIS-A type hardness is determined by a spring type hardness testing machine used in old JIS (JIS K 6301).

In the cured product, the cross-linked castable silicone rubber serves as a hard segment and has decisive influence on the properties as an elastic body.

In the cured product, the silicone high polymer serves as a soft segment and has decisive influence on the properties as a viscous body.

By adjusting the proportions of the hard and soft segments, a cured product exhibiting desired tan δ is obtained.

### (Method for Producing a Cured Product)

Firstly, each component of the silicone admixture according to the present embodiment is mixed to prepare a mixed liquid. For mixing, a mixer and the like may be used. The pot life of the castable silicone rubber admixture containing the vulcanizing agent is short. Thus, mixing is implemented just before use. “Just before use” herein means within 2 hours, preferably within 1 hour of before starting to use.

By heating the mixed liquid (silicone admixture) at the curing temperature (temperature for addition reaction) of the castable silicone rubber for a predetermined period of time, it is possible to obtain a cross-linked and cured product of the castable silicone rubber. For example, if KE-1950-3A and KE-1950-3B (manufactured by Shin-Etsu Chemical Co., Ltd.) are used as castable silicone rubbers, they are preferably heated at 110° C. or more for tens of seconds to a few minutes to cure.

The cured product may be subjected to a post curing (secondary curing) as necessary. In the secondary curing, the cured product is heated at, for example, 150° C. for 1 hour. The secondary curing can improve mechanical properties (for example, tensile strength) of the cured product. By subjecting the cured product to the secondary curing, the amount of the low-molecular weight siloxane remaining on the cured product can be reduced (about 2,000 ppm).

The curing temperature of the castable silicone rubber (110° C. or more) is lower than the curing temperature of the millable silicone rubber (170° C. or more). By employing the castable silicone rubber, the cured product can be produced at a lower temperature thereby keeping the energy consumption required for production low.

The rate of the addition reaction of the castable silicone rubber using a platinum compound as a catalyst is faster than the rate of the condensation reaction of the millable silicone rubber. The curing time of the castable silicone rubber subjected to an addition reaction is about one sixth to one tenth of the curing time of the millable silicone rubber. By employing the castable silicone rubber, the production time can be shortened, and as a result, the production cost can be kept low.

### Application Example_Ink:

If the silicone admixture is applied to an ink, the mixed liquid is printed onto a printing substrate (substrate) by silk screen printing and the like, and then the printing substrate is heated to a curing temperature. For a material of the printing substrate, a material having a melting point that is higher than the curing temperature of the silicone admixture is selected. The heating temperature is a temperature that is lower than the melting point of the substrate and higher than the curing temperature.

By employing the castable silicone rubber that is cured at a lower temperature and in a shorter period of time than the millable silicone rubber, there are more available choices of the material for the printing substrate than when the millable silicone rubber is used. For example, it is possible to employ thermoplastic resins and synthetic fibers and the like as a material for the printing substrate.

By employing the castable silicone rubber, it is possible to cure the ink at a temperature that is lower than the melting point of the printing substrate. Therefore, the printing substrate is prevented from heat damage even if it is heated and cured together with the ink.

A liquid castable silicone rubber of addition-reaction type has a lower viscosity than a millable silicone rubber. The ink applied with the silicone admixture according to the present embodiment is easier to handle and conforms more easily to the printing substrate than when the millable silicone rubber having higher viscosity is applied.

### Application Example_Molding Material:

If the silicone admixture is applied to a molding material, a mold is filled with the mixed liquid, and then the mold filled with the mixed liquid is heated to a curing temperature (a temperature for addition reaction) of the castable silicone rubber for a predetermined period of time to obtain a cross-linked and cured product of the castable silicone rubber. The curing temperature is, for example, 110° C. or more.

By employing the castable silicone rubber, an adhesive molding not only with a metal but also with a rubber, a thermoplastic resin, or the like is possible.

By using the liquid castable silicone rubber having a lower viscosity than the millable silicone rubber, the viscosity of the silicone admixture can be reduced, and it becomes easier to fill the mold. In addition, a molded product can be obtained in a shorter period of time than when the millable silicone rubber is used.

The LIMS using the silicone admixture according to the present embodiment as a molding material is suitable for no burr and runnerless molding, and the molding process can be automated depending on the shape of the product. The silicone admixture according to the present embodiment is suitable as a molding material used for press molding system. In the press molding, it is preferable to thoroughly defoam the mixed liquid before heating.

### EXAMPLES

### Example 1

### Materials:

### (A) Castable Silicone Rubber

KE-1950-3A, KE-1950-3B (manufactured by Shin-Etsu Chemical Co., Ltd.; KE-1950-3A contains a vulcanizing agent)

### (B) Silicone High Polymer

TSE200 (manufactured by Momentive Performance Materials Japan LCC)

### (C) Plasticizer

KE96-100 (manufactured by Shin-Etsu Chemical Co., Ltd.; kinematic viscosity of 100 mm³/s at 25° C.)

### (D) Reinforcing Agent

Nipsil LP (manufactured by Tosoh Silica Corporation; precipitated silica particles (powder))

### (E) Lubricant

RN-1 (manufactured by Wacker Asahikasei Silicone Co., Ltd)

Based on 100 parts by weight of the abovementioned component A, 26 parts by weight of the abovementioned component B, 42 parts by weight of the abovementioned component C, 0 part by weight of the abovementioned component D, and 0.2 parts by weight of the abovementioned component E were mixed to prepare a silicone admixture (mixed liquid).

The silicone admixture was introduced into a mold and was subjected to a heating at 120° C. for 1.5 minutes to cross-link the castable silicone rubber, thereby obtaining a cured product of the silicone admixture.

The physical properties of the obtained cured product were evaluated. As a comparison, the millable silicone rubbers (Comparative Example 1: ELASTOSIL® EL 7101 manufactured by Wacker Asahikasei Silicone Co., Ltd, and a low-viscosity silicone oil; Comparative Example 2: ELASTOSIL® EL 7101 manufactured by Wacker Asahikasei Silicone Co., Ltd) were used instead of the abovementioned castable silicone rubber to prepare a silicone admixture; the silicone admixture was heated at 170° C. for 10 minutes to obtain a cured product with the cross-linked millable silicone rubber; and the physical properties were evaluated in the same way. The results are shown in Table 1.

TABLE 1

| | | COMPARATIVE | COMPARATIVE |
|---|---|---|---|
| PROPERTY | EXAMPLE 1 | EXAMPLE 1 | EXAMPLE 2 |
| HARDNESS | 8° | 2° | 10° |
| TENSILE | 1 MPa | 0.8 MPa | 4.5 MPa |
| STRENGTH | | | |
| ELONGATION | 180% | 1110% | 1080% |
| AT BREAK | | | |
| TEAR | 2N/mm | — | 7N/mm |
| STRENGTH | | | |
| tan δ | 0.26 | — | — |

1 Type A durometer
2, 3 The cured product was punched to obtain a test piece in the form of type-3 dumbbell, and the obtained test piece was used to conduct tensile test according to JIS C 3005. The tensile test was conducted under the conditions of tension rate of 500 mm/min and interval between gauge marks of 20 mm to measure tensile strength (MPa) and elongation at break (%).
5 For a test piece having a width of 10 mm and a length of 40 mm, the storage modulus E′ and the loss modulus E″ of the test piece were determined at various measurement frequencies using a viscoelasticity measuring apparatus (DMS6100 manufactured by SII Nano Technology Inc.). The measuring conditions were as follows: measuring mode of tension, displacement amplitude of 20 μm, measurement temperature of 25° C., measurement frequencies of 0.01 to 100 Hz. The ratio of the loss modulus E″ to the storage modulus E′ (E″/E′) was defined as tan δ. Table 1 shows the tan δ values at 30° C. . . .

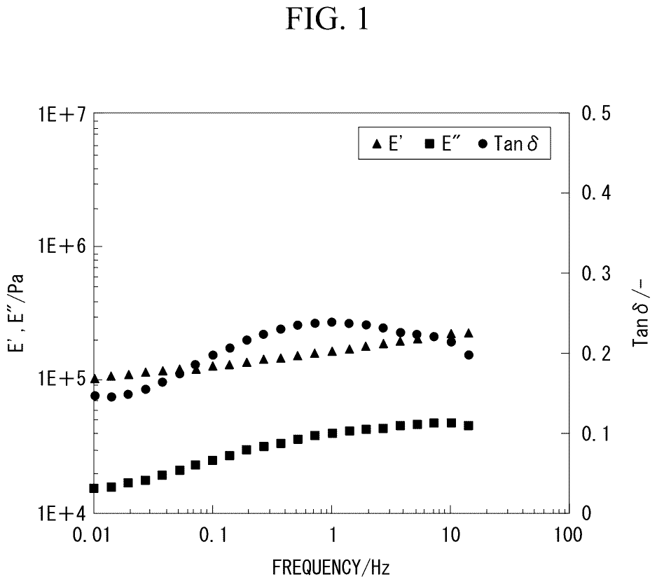

FIG. 1 is a graph of the frequency-dependent dynamic viscoelasticity of the abovementioned Example 1. According to FIG. 1, the storage modulus E′ and the loss modulus E″ of the cured product of Example 1 increased as the frequency increased. The tan δ of the cured product of Example 1 was the highest at around 1 Hz. Therefore, it was confirmed that the cured product of Example 1 has a frequency dependency (dilatancy). The cured product of Example 1 had tan δ of 0.2 or more.

A reason for the cured product of Example 1 exhibiting a dilatancy is that “continuous thermal motion of polymer molecules” occurs in the temperature region of near room temperature.

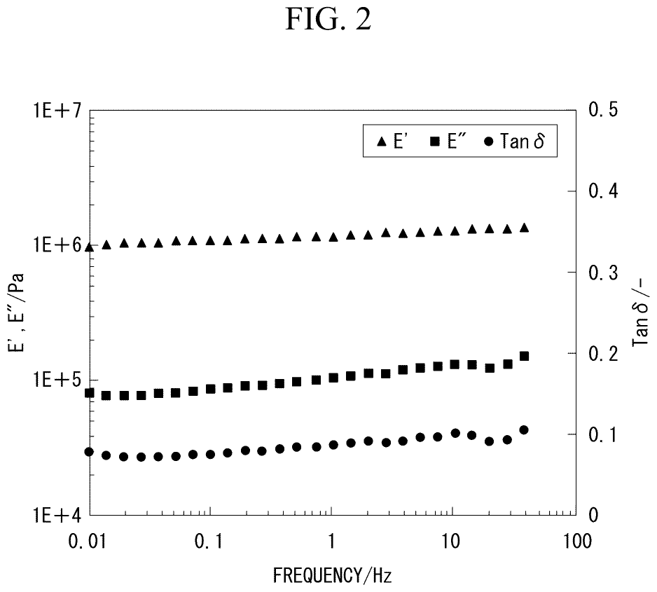

FIG. 2 is a graph of the frequency-dependent dynamic viscoelasticity of a cured product as Comparative Example 3 that was formed by cross-linking the abovementioned castable silicone rubber (A) under the same conditions. According to FIG. 2, when only the castable silicone rubber was cured, the storage modulus E′ and the loss modulus E″ had tendencies to slightly increase as the frequency increased, but no peak value for tan δ was observed. Therefore, it can be said that the cured product of Comparative Example 3 did not have a dilatancy.

It has been confirmed that the cured products of Comparative Examples 1 and 2 hardly exhibit a dilatancy.

In addition, in a test whereby KE-76BS (manufactured by Shin-Etsu Chemical Co., Ltd.,) was used instead of TSE200 as a silicone high polymer (B), it has been confirmed that the cured product showed similar dilatancy as Example 1.

### Examples 2 and 3

The material formulation of Example 1 was varied to prepare a silicone admixture (mixed liquid), and then a cured product was obtained in the same way as Example 1 (Examples 2 and 3). The dynamic viscoelasticity of the obtained cured product was evaluated in the same way as in Example 1. The amounts of material components for Examples 2 and 3 are shown in Table 2.

TABLE 2

| MATERIAL | EXAMPLE 2 | EXAMPLE 3 |
|---|---|---|
| A | 100 PARTS | 100 PARTS |
| | BY WEIGHT | BY WEIGHT |
| B | 40 PARTS | 30 PARTS |
| | BY WEIGHT | BY WEIGHT |
| C | 60 PARTS | 37 PARTS |
| | BY WEIGHT | BY WEIGHT |
| D | — | — |
| E | — | — |

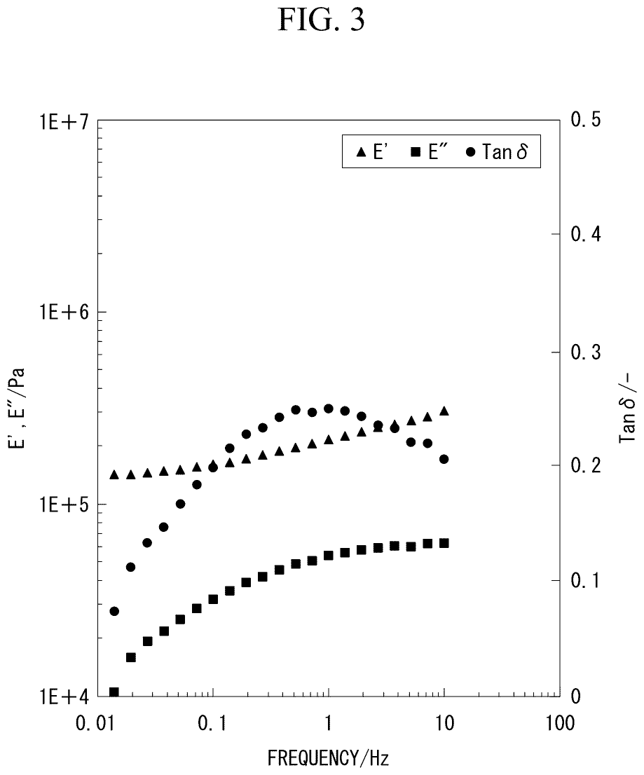

FIG. 3 is a graph of the frequency-dependent dynamic viscoelasticity of Example 2. FIG. 3 indicates a clear dilatancy from E′ and E″, and tan δ of 0.2 or more is observed between 0.1 and 10 Hz, especially at 1 Hz, which is the central frequency of human movement.

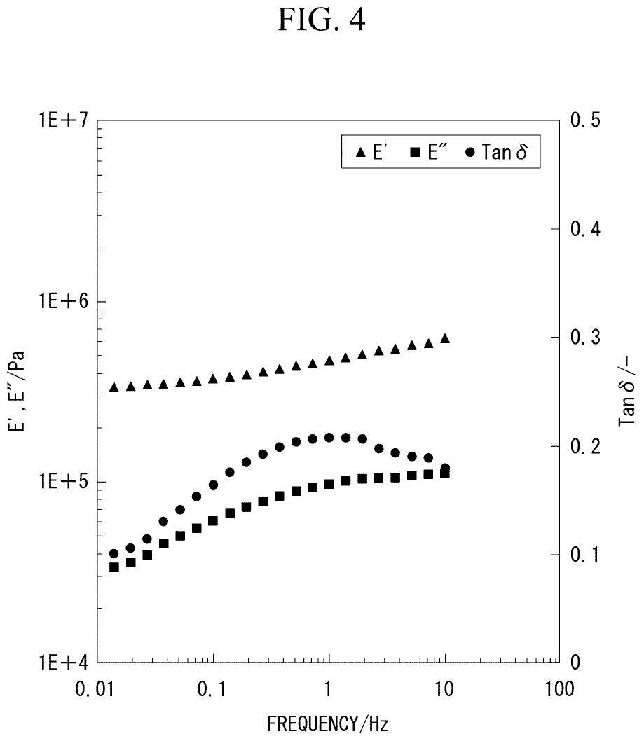

FIG. 4 is a graph of the frequency-dependent dynamic viscoelasticity of Example 3. FIG. 4 indicates a clear dilatancy from E′ and E″, and tan δ of 0.2 or more is observed between 0.2 and 5 Hz, especially at 1 Hz, which is the central frequency of human movement.

FIGS. 1, 3, and 4 show the measurement results at 30° C., but it has been confirmed that the measurements within the range of 10° C. to 40° C. give the results of similar trend as in FIGS. 1, 3, and 4.

What is claimed is:

1. A silicone admixture, comprising:
a castable silicone rubber;
a vulcanizing agent; and
a silicone high polymer having no cross-linking site,
wherein the silicone admixture is capable of becoming a cured product having loss tangent (tan δ) of 0.2 or more at 10° C. to 40° C.

2. The silicone admixture according to claim 1, wherein the castable silicone rubber is a liquid silicone rubber that is curable by addition reaction; and
the vulcanizing agent is a platinum compound.

3. The silicone admixture according to claim 1, wherein the silicone high polymer having no cross-linking site is a dimethyl silicone high polymer.

4. The silicone admixture according to claim 1, wherein the silicone admixture comprises 20 parts or more by weight of the silicone high polymer having no cross-linking site based on 100 parts by weight of the castable silicone rubber.

5. The silicone admixture according to claim 1, further comprising a low-viscosity silicone oil having no methyl group within a molecule.

6. An ink comprising the silicone admixture according to claim 1.

7. A molding material comprising the silicone admixture according to claim 1.

8. A cured product of the silicone admixture according to claim 1.

9. A method for producing a cured product, comprising:
mixing a castable silicone rubber, a silicone high polymer having no cross-linking site, and a vulcanizing agent to prepare a mixed liquid;
printing the mixed liquid onto a substrate having a higher melting point than a curing temperature of the mixed liquid; and
heating the substrate printed with the mixed liquid to a temperature lower than the melting point of the substrate and higher than the curing temperature and obtaining the cured product having loss tangent (tan δ) of 0.2 or more at 10° C. to 40° C.

10. A method for producing a cured product, comprising:
mixing a castable silicone rubber, a silicone high polymer having no cross-linking site, and a vulcanizing agent to prepare a mixed liquid;
filling a mold with the mixed liquid; and
heating the mold filled with the mixed liquid to 110° C. or more and obtaining the cured product having loss tangent (tan δ) of 0.2 or more at 10° C. to 40° C.
